(19) United States
(12) Patent Application Publication
(10) Pub. No.: US 2019/0191639 A1
(43) Pub. Date: Jun. 27, 2019

(54) AUTOMATED INDOOR CANNABIS GROWING FACILITY AND METHODOLOGY

(71) Applicant: GrowLife, Inc., Kirkland, WA (US)

(72) Inventors: Marco Hegyi, Woodinville, WA (US); David Paul Reichwein, Elizabethtown, PA (US)

(21) Appl. No.: 16/010,192

(22) Filed: Jun. 15, 2018

Related U.S. Application Data
(60) Provisional application No. 62/610,275, filed on Dec. 25, 2017.

(51) Int. Cl. A01G 22/00; A01G 9/14; A01G 9/02; A01G 9/20; A01G 27/00; A01G 9/24; F21V 21/34

(52) U.S. Cl. CPC A01G 22/00; A01G 9/14; A01G 9/023; F21Y 2115/10; A01G 27/003; A01G 9/24; F21V 21/34; A01G 9/20

(57) ABSTRACT

A method of growing plants includes providing a plant growing apparatus that includes a vertical stack plant assembly including plant pot holders for pots, a movable light array adjustable to allow effective light for the plants, and an outer shell assembly including at least one of a wall, a floor, a ceiling creating a grow room. Potted plants are placed in the grow room, and light, water, and nutrients are provided to the plants, where the light is provided by the movable light array, water is provided by a watering system, and nutrients are provided by a nutrient delivery system. A plant growing apparatus includes a vertical stack plant assembly including plant pot holders for pots, a movable light array adjustable to allow effective light for the plants, and an outer shell assembly including at least one of a wall, a floor, and a ceiling creating a grow room.

### CROSS-REFERENCE TO RELATED APPLICATIONS

This application claims benefit under 35 U.S.C. 119 to U.S. application Ser. No. 62/610,275 filed on Dec. 25, 2017, and incorporated herein by reference in its entirety.

### BACKGROUND

In the burgeoning medical cannabis plants industry, the supply chain of growing facilities is operated by a multitude of licensees utilizing random facility construction practices and materials, and a grow methodology that is driven by a “master grower's” experience. While this method of growing cannabis plants is effective, the yield, quality, and cost can be highly variable. With the exponential rise in use of medical cannabis plants to minimize opiate use, the medical cannabis plants supply chain will consolidate based on best practices and cost. Existing growing systems include but are not limited to hydroponics, soil, or aeroponics that provide a medium to deliver nutrients to plant roots that are positioned either horizontally or vertically. The nutrient medium can be any fluid, solid material, or combinations that provide for root support and allow delivery of nutrients to the plant. These systems also employ a lighting component to provide photosynthesis energy required for plant growth. Existing grow house construction materials, operating practices, and grow methodologies are highly variable and kept confidential as each grower believes his or her methods and the quality are best. Currently, there is a high degree of variability in medical cannabis plants purity and cost. Further, the existing supply chain methodology will not be able to meet future demand of quality low-cost medical cannabis plants. Thus, there is a need for a system that achieves high plant yield and consistent quality at reduced unitized cost.

### BRIEF SUMMARY

A method of growing plants includes providing a plant growing apparatus, the apparatus including a vertical stack plant assembly, wherein the vertical stack plant assembly includes rows of plant pot holders for pots, said pots adapted to include grow medium and plants; a movable light array, wherein the position of the movable light array with respect to the plant pot holders is adjustable to allow light from the movable light array to be in an effective, possibly optimal position for growing plants in the plant pot holders of the vertical stack plant assembly; and an outer shell assembly including at least one of a wall, a floor, a ceiling, and combinations thereof, thereby creating a plant space, wherein the plant space includes the vertical stack plant assembly and the movable light array. The method further includes placing pots including grow medium and plants into the plant pot holders, providing light, water, and nutrients to the plants, wherein the light is provided by the movable light array, water is provided by a watering system, and nutrients are provided by a nutrient delivery system, monitoring at least one of the environmental conditions, the grow medium composition, the condition of the grow medium, plant health, and combinations thereof, and adjusting at least one of the position of the movable light array to provide optimal light to the plants, the quantity of water and frequency of delivery of water by the watering system to provide optimal moisture to the plants, the quantity and type of nutrients and frequency of delivery of nutrients by the nutrient delivery system to provide selectively specialized nutrients to the plants, and combinations thereof.

A plant growing apparatus may include a vertical stack plant assembly, wherein the vertical stack plant assembly includes rows of plant pot holders for pots, said pots adapted to include grow medium and plants; a movable light array, wherein the position of the movable light array with respect to the plant pot holders is adjustable to allow light from the movable light array to be in an effective, possibly optimal position for growing plants in the plant pot holders of the vertical stack plant assembly; and an outer shell assembly including at least one of a wall, a floor, a ceiling, and combinations thereof, thereby creating a plant space, wherein the plant space includes the vertical stack plant assembly and the movable light array.

A plant growing system may include a vertical stack plant assembly, wherein the vertical stack plant assembly includes rows of plant pot holders for pots, said pots adapted to include grow medium and plants; a movable light array, wherein the position of the movable light array with respect to the plant pot holders is adjustable to allow light from the movable light array to be in an effective, possibly optimal position for growing plants in the plant pot holders of the vertical stack plant assembly. The movable light array may include light assembly including at least one grow light; a frame assembly including a frame, wherein the light assembly is mounted on the frame assembly and a track assembly, wherein the track assembly includes a track that accepts a portion of the frame assembly and facilitates movement of the frame assembly toward or away from the vertical stack plant assembly. The system may further include an outer shell assembly including at least one of a wall, a floor, a ceiling, and combinations thereof, thereby creating a plant space, wherein the plant space includes the vertical stack plant assembly and the movable light array. The outer shell assembly may include an internal surface exposed to the plant space and an external surface not exposed to the plant space, wherein the internal surface includes at least one of wall materials that reflect light, ceiling materials that reflect light, floor materials that reflect light, and combinations thereof. The system may further include a nutrient delivery system for delivering nutrients to the plants, a watering system for watering the plants, a control system; and a monitoring system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a plant growing apparatus 100 in accordance with one embodiment.

FIG. 2 illustrates a plant space 200 in accordance with one embodiment.

FIG. 3 illustrates a plant space 300 in accordance with one embodiment.

FIG. 4 illustrates a plant space 400 in accordance with one embodiment.

FIG. 5 illustrates a movable light array 500 in accordance with one embodiment.

FIG. 6 illustrates a vertical stack plant assembly 600 in accordance with one embodiment.

### DETAILED DESCRIPTION

Disclosed herein are embodiments of a solution to the medical cannabis plants supply chain problem by utilizing a method, system, and apparatus for growing plants, including cannabis plants. In an embodiment a large, scalable commercial vertical growing system is provided that creates a highly automated and controlled growing environment which includes plant pot holders located either in linear or circular multi-level stacks perpendicular to the light assemblies. Lighting systems are strategically positioned to the plant vertical stack so that each plant receives the desired intensity and frequency of light. Automated nutrient delivery systems are embedded in the rack system or delivered by a movable robotic feeding system, so each plant can receive a custom nutrient feed and amount. The invention utilizes a combination of a space efficient vertical stack plant assembly, a movable light array, and thermodynamics to achieve maximum plant yield and consistent quality at the lowest unitized cost.

Different species of plants may be grown using the methods, systems, and apparatuses disclosed herein. The plants may include cannabis, flowers, microgreens, herbs, vegetables, ginseng, and other biomass such as mushrooms, but are not limited thereto. Although references to cannabis plants are made throughout the disclosure, those methods, systems, and apparatuses may be also be applied to plants and biomass.

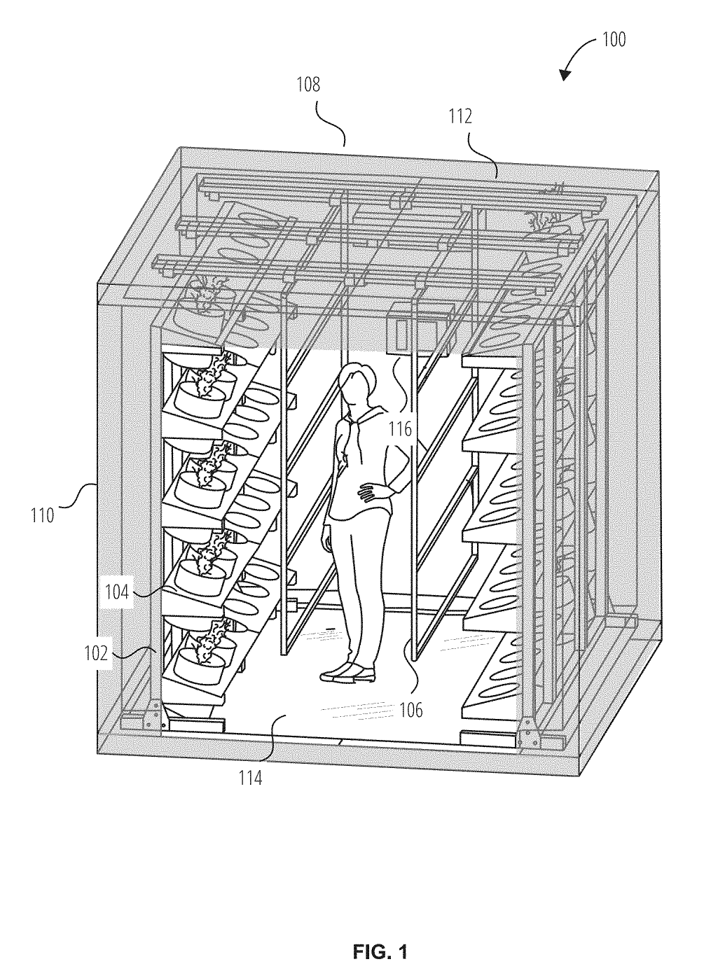

Referring to FIG. 1, a plant growing apparatus 100 may comprise a vertical stack plant assembly 102, rows of plant pot holders 104, a movable light array 106, an outer shell assembly 108, a wall 110, a ceiling 112, a floor 114, and environmental condition controls 116. A plurality of plant growing apparatus 100 may be used to construct a cubical farm.

Cubical Farm

In traditional grow operations, approximately 4 to 5 plants are placed in about 25 square feet of floor space. The present invention provides several apparatuses that may accommodate an increase in the amount of plants per square foot. In an exemplary embodiment, the apparatus is a cube that is stackable with other cubes. The cube may contain a vertical stack plant assembly 102, a movable light array 106, and environmental condition controls. The volume within the cube may be considered a plant space, which may or may not allow the regular entrance of or physical interaction with the grower. The cube may be self contained, thereby allowing a grower to create a microclimate in the plant space within the cube. The plant space and the grower space may be bifurcated to the greatest extent possible to maintain the most purified growing space possible for the cannabis plants.

The “cube” may be a square box or a different shape such as a rectangular box or a circular box. In an exemplary embodiment, the cube is an 8 foot×8 foot×8 foot box. A cube of this size may allow up to 70 plants in about 64 square feet of floor space. There are no limitations on size and number of plants in a vertical plant stack assembly. The available floor space, configuration of the light and nutrient delivery system assembly and design of the vertical stack plant assembly 102 may be used to determine the optimum size and geometry of each facility.

The cube may be modular in design, thereby allowing one cube to be stacked on another cube. A cubical farm may be formed by as few as two cubes stacked on one another or next to each other. Each cube may have a hookup for power, a water intake, and an effluent out connection, thereby allowing for rapid expansion of the cubical farm. If additional growing space is desired, a grower may simply add a cube, provide power, water, and effluent removal hookups to the new cube. This modular arrangement allows expansion of the cubical farm without having to disturb the existing cubes in the cubical farm. Within the cubical farm, the environmental condition controls 116 of each cube may be independent, but the data collection, monitoring and control system may all be linked together. The environmental condition controls 116 may also be provided from a central location for all of the cubes in the cubical farm.

The modular cubes allow for growing different strains of plants within the same cubical farm. Each cube may contain a different strain of plant or multiple strains of plants. If each cube is isolated from the other, cross-contamination between different strains may not occur. If one cube has a problem, such as disease, low productivity, or environmental condition controls 116 failure, the problem may be isolated to only the one cube.

The cubical farm may also include a detoxification chamber. The detoxification chamber provides an area where personal protective wear may be applied before a grower is allowed to enter the plant space.

Outer Shell Assembly

The outer shell assembly 108 may include at least one wall 110, a ceiling 112, and a floor 114. In some embodiments, multiple walls 110 and a ceiling 112 may be added to a space that has an existing floor 114.

The wall 110, ceiling 112 and or floor 114 may include a material that reflects light back into the room. An example of a commercially available material is LUMI, available from GrowLife Innovations in Kirkland, Wash. In addition reflecting light, because of its composition, it's a good thermal conductor of heat, because it has a large percentage of iron ferrite and other components that allow it to transfer heat well. Copper foil may be placed under the floor 114 or behind the inner surface of the wall 110 or ceiling 112, before installing the reflective tiles on top of the copper foil. The copper foil may be thermally grounded to the earth so that heat generators in the plant space have their heat shunted passively outside of the room. These heat generators may include the movable light array 106. Therefore, as heat reaches the wall 110, the ceiling 112, or the floor, it is transferred out through the thermal ground in the earth.

To further increase the thermodynamic efficiency of the cubical farm, the outer shell vertical stack plant assembly 102 may include an internal surface exposed to the plant space, an external surface not exposed to the plant space, and a vacuum layer between the internal surface and the external surface. The vacuum layer may provide thermal isolation between the internal surface and the external surface of at least one of the wall 110, ceiling 112, and floor 114 of the outer shell assembly 108. The material in the vacuum layer may include a honeycomb lattice. In some embodiments the outer shell assembly 108 includes dual wall stainless steel materials with a honeycomb lattice between them. To construct this dual wall material, holes may be drilled in each of the sides of the hexagons in the honeycomb lattice to allow airflow, and then a vacuum is pulled on the interior of the dual wall materials. The resulting structure may have improved thermodynamic efficiency in part because heat gain from the external environment is reduced.

If magnetic wave and radio frequency control is desired, the wall 110, the ceiling 112, and the floor may be enmeshed in a grounded copper wire mesh to effectively create a Faraday Cage to block magnetic waves and radio frequencies.

The wall 110, floor 114, and ceiling 112 materials may be toxin free, water proof, antimicrobial by design, and easy to clean with purified water. A commercially available example of these materials is FREEFIT™ “Lotus” Surfacing, which is available from GrowLife Innovations in Kirkland, Wash. All ancillary items such as Storage Racking, Pipes, Wires, Paint, Conduits, Lighting, etc., may utilize toxin free materials. By controlling every surface material and environmental variable, a clean room environment may be created.

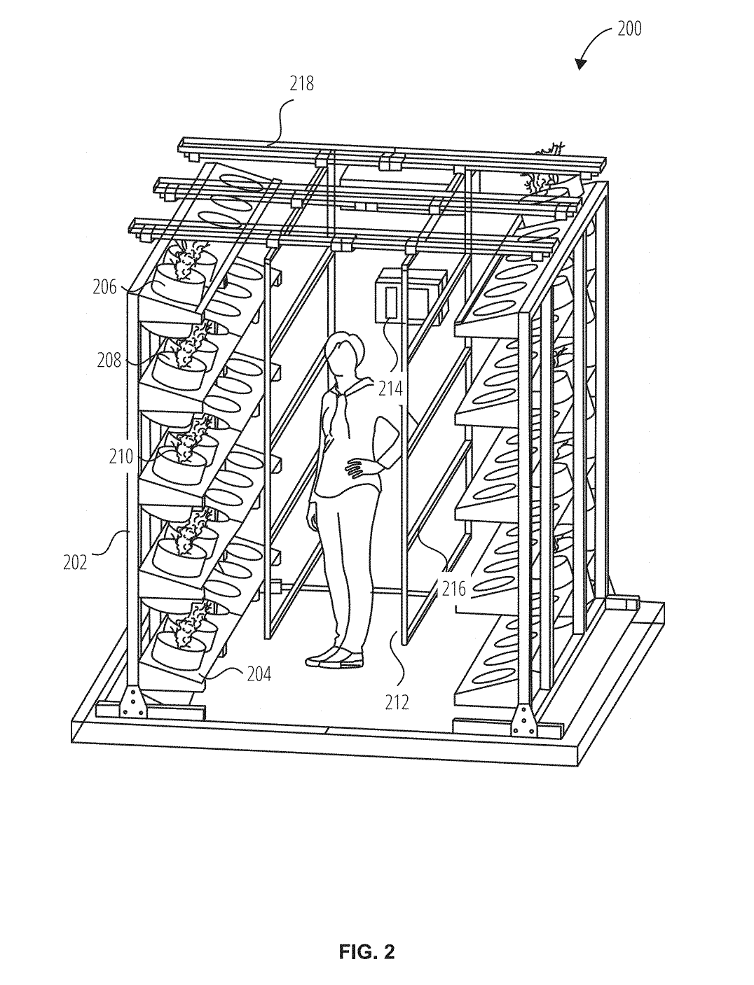

As shown in FIG. 2, the plant space 200 may comprise a vertical stack plant assembly 202, rows of plant pot holders 204, pots 206, grow medium 208, plants 210, a movable light array 212, an environmental condition controls 214, a frame assembly 216, and a track assembly 218.

Vertical Stack Plant Assembly

The cubes of the present invention include a vertical stack plant assembly 202. The multi-level vertical stack assembly may include linear rows of plant pot holders 204 located around and substantially perpendicular to the movable light array 212. The multi-level stack assembly may also include circular rows of plant pot holders 104, in which case the movable light array 212 may also have a curved shape. The vertical stack plant assembly 202 may be designed to maximize the number of plants 210 within a given volume. One of skill in the art will realize that the spacing of the plant pot holders may adjusted for different types of plants 210.

In some traditional growing operations, the plants themselves are moved toward or away from a stationary light source as they grow. By contrast, certain embodiments of the present invention include a stationary vertical stack plant assembly, whereby instead of moving the plants towards or away from the light source, the light source itself is moved. The design of the vertical stack plant assembly allows for the pots to be at the strategic angle and position relative to the movable light array. The vertical stack plant assembly may be a trellised structure with holes for pots that are angled toward the movable light array. The vertical stack plant assembly 202 may be anchored to at least one of the wall or the floor.

The vertical stack plant assembly may include a mechanical means that allows each individual plant to be positioned or removed independent of other plants within the vertical stack plant assembly. In an embodiment, a removable retaining bar allows for the removal of individual plants, particularly those located in the upper portion of the plant space. The positioning may also include rotating the pots 206 in the rows of plant pot holders 204 using a pot rotating system, wherein the pot rotating system adjusts the orientation the plant pots 206 with respect to the movable light array 106 by rotating the pots 206 in the vertical stack plant assembly 202.

Movable Light Array

The cubes of the present invention include a movable light array 212. The movable light array 212 may include a light assembly (not shown in FIG. 2) including at least one grow light, a frame assembly 216 including a frame, wherein the light assembly is mounted on the frame assembly 216, and a track assembly 218, wherein the track assembly 218 includes a track that accepts a portion of the frame assembly and facilitates movement of the frame assembly 216 toward or away from the vertical stack plant assembly 202. If the vertical stack plant assembly 202 includes circular rows of plant pot holders 104, portions of the movable light array 212 may also have a curved shape, including elements of the frame assembly 216 such as the frame itself.

A portion of the frame assembly may be configured to slide in the track included in the track assembly 218. The portion may include a section with a T shape that is accepted into the track thereby allowing the frame assembly 216 to suspend from the track and move along the track toward or away from the vertical stack plant assembly 202. The portion of the frame assembly with a T shape may include wheels to allow for smooth sliding along the track in the track assembly 218.

A portion of the frame assembly may also be configured with a clip or ring that slides on the outside of the track as seen in FIG. 2. The sliding clip or ring may also be located on the track, and the portion of the frame assembly attaches to the sliding clip or ring.

In traditional growing, a large percentage by volume of light and the energy associated with the light is wasted. The traditional techniques may have lights mounted 30 feet above the plant canopy. This means that a large light needs to be used to provide enough light to a plant leaf 30 feet away. By contrast, as the plants 210 grow in the present invention, the light assembly may be moved to optimize the delivery of light to the plant. Initially, the light assembly may be in a position to deliver light 6 inches from the plants 210. To maintain this 6 inch distance as the plant grows, the movable light array 212 may be moved toward the center of the plant space 200. To control the distance from the plant canopy, an ultrasonic sensor may be used to measure distance from the plant canopy to the movable light array 212. A control system may then and then the movable light array 212 may slide on the track assembly 218, automatically indexing towards the middle of the plant space 200 from both sides.

Environmental Control and General Control

All properties of the environment may be controlled and managed including but not limited to: barometric pressure, humidity, ionization, O₂ level, CO₂ level, magnetic fields, pathogens, air flow, plant temperature (root, stem, and leaf), Schumann resonant frequency, microbe monitoring, sound waves, light levels and frequencies, pH monitoring, density and dose from the nutrient delivery system, water temperature, nutrient temperature, effluent temperature. Atmospheric conditions may be part of environmental conditions and vice versa.

To control and/or monitor the environment within the plant space 200, a heating, ventilation and air conditioning system (HVAC system) may be used. Light delivery to the plants 210 may be controlled by adjusting the distance of the movable light array 212 from the plants 210.

The cubical farms of the present invention may further include cultivation and drying facilities. The facilities may be fully automated, monitored, and controlled.

As part of the general control system, a database of all manufacturing processes and yield data may be maintained to learn and improve the production of plants 210. The general control system may utilize self-learning manufacturing technology, to allow for machine initiated alterations to the manufacturing processes. All process variables may be input to a computer system for real time algorithmic input and response. There are no limitations on size and number of plants in a vertical plant stack assembly. The available floor space, configuration of the light and nutrient delivery system assembly and design of the vertical plant stack assembly determine optimum size and geometry of each facility.

Monitoring System

The environmental condition controls 214 may be linked to a monitoring system. The monitoring system may be part of the environmental condition controls 214, a general control system, or be a separate function from them. The monitoring system may monitor at least one of barometric pressure, humidity, ionization, O₂ level, CO₂ level, magnetic fields, pathogens, air flow, plant temperature (root, stem, and leaf), Schumann resonant frequency, microbe monitoring, sound waves, light levels and frequencies, pH monitoring, density and dose from the nutrient delivery system, water temperature, nutrient temperature, effluent temperature.

Cameras may be utilized to monitor activities within the plant space 200, or outside of the outer shell assembly 108. Cameras may monitor the distance of the movable light array 212 from the plants 210. High resolution cameras and advanced environmental monitoring systems may be mounted in the plant space 200, or may be mounted on monitoring drones that are controlled remotely by technicians. Cameras may also be used to monitor the health of individual plants 210, or sections of the plant canopy.

If a sample is needed from any of the plants 210, test or diagnostic drone may be used to obtain a clipping from a plant for lab testing.

Magnetic and radio waves may be monitored, and a Schumann resonant frequency pulse generator may be utilized to maintain an ambient magnetic pulse frequency. The ambient magnet pulse frequency may be 7.83 Hz.

Electrical power utilization may be monitored such that electrical power usage is minimized to the greatest extent possible through use of advanced alternative power generation equipment and sound power management procedures. Because the plant growing systems and methods of the present invention may be viewed as a complete terra system and not discrete elements, effective power management and control systems may be utilized.

Grow Medium

The plants 210 may be grown in grow medium 208, which may be determined by the growing technique including hydroponics, soil, and aeroponics. Aeroponics is practiced without grow medium 208, although water may be used to deliver and transmit nutrients to the plants 210. Selection of grow medium may depend on the type of plants and/or the needs of the plant growing system. Some factors considered may be pH balance, water retention properties, and aeration abilities. Different materials for soil and hydroponic systems may include, but are not limited to, at least one of expanded clay, peat moss, coco coir, gravel, Rockwool, sand, perlite, vermiculite, diatomite, glass, and combinations thereof.

Watering System

The plant growing apparatuses, methods, and systems of the present invention may include a watering system. The watering system may deliver water to the top of the plant and pots 206 or the bottom of the pots 206. For top delivery, numerous methods may be utilized, including sprinklers, drippers, and misting systems. Water may also be delivered hydroponically, using a water pump and pot drain system to provide and remove water from watering vessels. The watering vessels may receive the pots 206 such that an inner pot (contains plant) and outer pot (contains plant pot and plant) arrangement is created. The watering vessels may be interconnected in parallel by fittings at their bases using tubing or hose, thereby forming a watering manifold. Because the watering system with the watering vessels is bottom fed, an ebb and flow system may be used to water the plants. A pump may fill and drain the watering vessels several times a day, allowing even watering. An additional advantage of utilizing the watering vessels is that plants may be removed by lifting out the inner pots without having to remove the watering vessels, thereby saving time and space. Effluent from the watering system may be directed outside of the growing apparatus.

The watering system may also be used to purify and detoxify well or city water while simultaneously augmenting the water with nutrients to facilitate maximum plant yield. By combining filtering and augmenting activities, the effluent from the watering system may be minimized.

Nutrient Delivery System

The plant growing apparatuses, methods, and systems of the present invention may include a nutrient delivery system for delivering a nutrient formulation to the plants 210. The nutrient formulation composition and quantity can be customized based on the unique needs of each plant. A nutrient medium may be used by the nutrient delivery system to deliver a nutrient formulation. The nutrient medium may be any fluid, solid material, and combinations thereof that provides for root support and allows delivery of nutrients to the plant.

The nutrient delivery system may be permanently mounted to a structure in the plant space 200, or may be dispersed through a movable robotic feeding system. The nutrient delivery system may be piped into the same delivery pipes/hoses used in the watering system described above, or may be a separate piping system to the plants 210.

In an embodiment, the nutrient delivery system includes a cartridge system that allows the nutrient delivery system to deliver nutrients to all of the plants at once. The canister may be an inline device in the delivery hose/pipe system to deliver nutrients to all the plants at once. The delivery system may include a positive displacement pump and a control solenoid. The canister may have a quick connect to allow easy installation and removal from the delivery hose/pipe system. When connected to a water or fluid supply, such as the watering system, the canister may dispense measured nutrients to the plants 210. The nutrient media used in the cartridge may be a solid mass that slowly dissolves, or sheds an exposed layer, when exposed to a fluid such as water. The solid mass may have different layers as one goes toward the center of the solid mass. Each layer may have a different composition of nutrients. The outer layers of the solid mass may contain nutrients beneficial to a young plant, and as the layers dissolve, the composition of nutrients that is dissolved is more beneficial to a more mature plant. Because the metered nutrient may be delivered to the plant for its entire life cycle, from clone to harvest, a grower may never have to manually feed it again. The canister may contain a cylinder with nutrients densely packed on it and/or inside of it. The outer nutrients on the outer walls of the cylinder may be nutrients that the plant needs at a young age. As the cylinder is exposed to a fluid such as water, the outer surface may be dissolved or eroded away, thereby exposing a different layer of nutrients to the fluid. The shape of the cartridge or the mass of nutrients may be any shape that fits into the canister. The shape may be a block, cylinder, sphere, ellipsoid, but is not limited thereto.

The terms “core portion” and “shell layer” of a cylinder or block refer to relative locations of the layers along a cross-section of the cylinder or block that is orthogonal to a longitudinal length of the cylinder or block, where the core portion is an inner layer relative to the shell layer. Additionally the term “core portion” and “shell layer” may be applied to the resulting nutrient cylinder or block created after the nutrient cylinder or block is eroded or dissolved by a nutrient delivery fluid.

The nutrient delivery system may include a nutrient delivery fluid, a canister in fluid communication with the nutrient delivery fluid, and a nutrient block inside of the canister. The nutrients may be present in multiple shell layers surrounding a core portion of the nutrient block, wherein the outer layers of the nutrient block include nutrients that are beneficial to plants at a young age, and the inner layers of the nutrient block include nutrients that are beneficial to plants at an older age. Upon exposure of the nutrient block to the nutrient delivery fluid, the outer layers of the nutrient block dissolve or erode into the nutrient delivery fluid, which carries the nutrients to the plants.

Harvesting

Harvesting of the plants 210 may be performed manually by growers by hand or with the assistance of a machine. The harvesting process may also be automated with the use of machines. In an embodiment, harvesting drones may be used to remove plants from the indoor grow facility and to move them to a harvesting platform. This automated plant extraction from the grow room for cultivation may be performed by an automatic storage and retrieval system to minimize human contact and possible contamination.

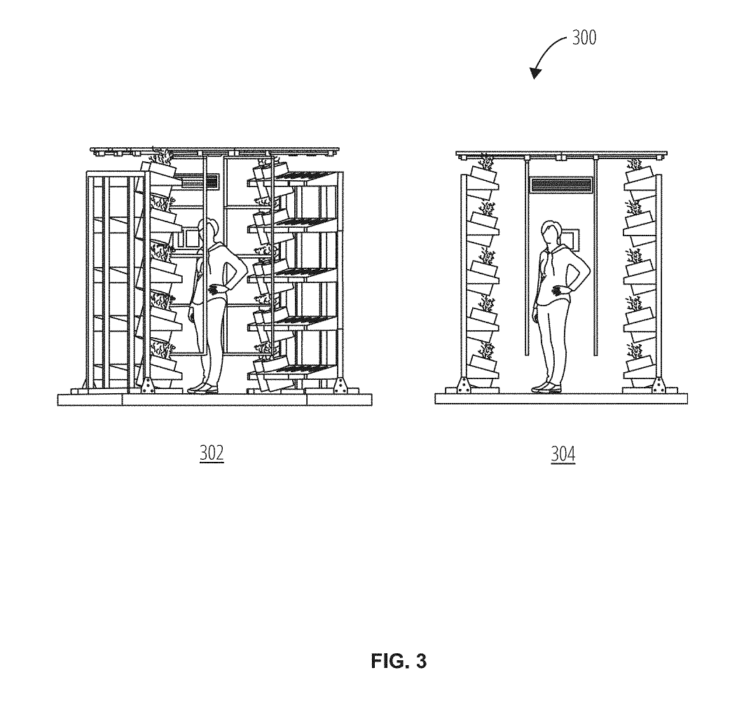

FIG. 3 illustrates two different views of the plant space 300. An angled view of the plant space 302 and an end view of the plant space 304 demonstrate the relative positions of the vertical stack plant assembly, movable light array, and environmental condition controls.

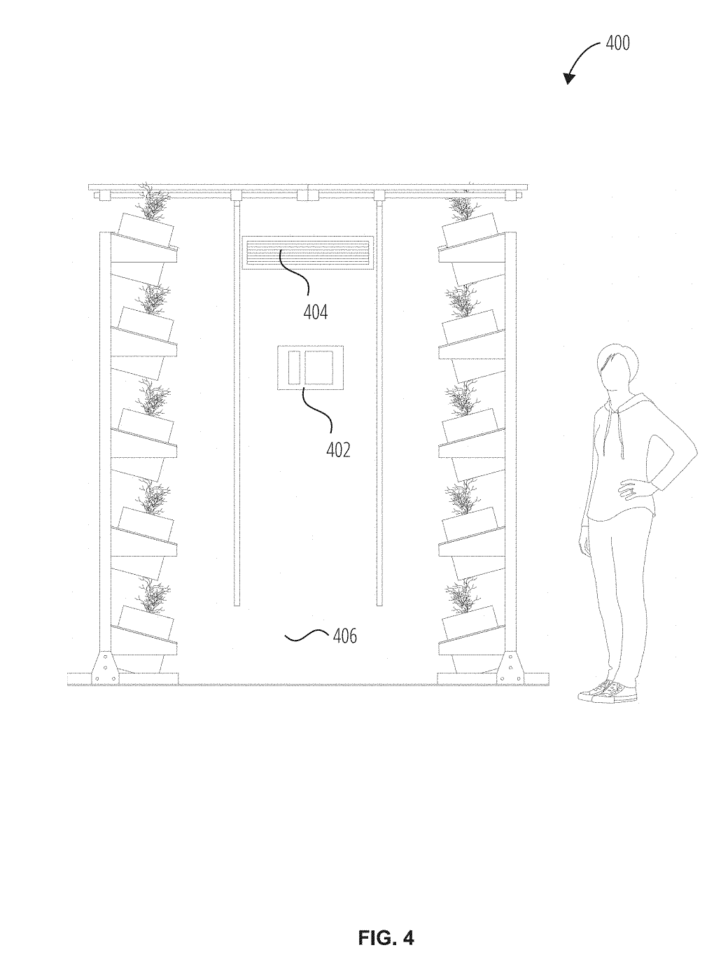

As shown in FIG. 4, a plant space 400 may include climate atmospheric condition controls 402, an HVAC system 404, and a plant space 406. The HVAC system 404 may be utilized to monitor and/or control at least one of air flows, humidity and temperatures throughout the plant space 406. The HVAC system 404 may be controlled by the climate atmospheric condition controls 402, a general control system, or by internal controls within the HVAC system. In an embodiment, the HVAC system 404 is a ductless unit mounted on a wall inside of the plant space 406.

The HVAC system 404 may also be part of a multi-zone, filtrated HVAC system that has a central unit in the cubical farm. In an embodiment, a centralized geothermal based cooling and heating system may provide cooling media through a geo-piping system to an HVAC system 404 in each cube assembly. With a centralized ground heat exchanger servicing all of the units in the cubical farm, individual closed loop fields may not be necessary.

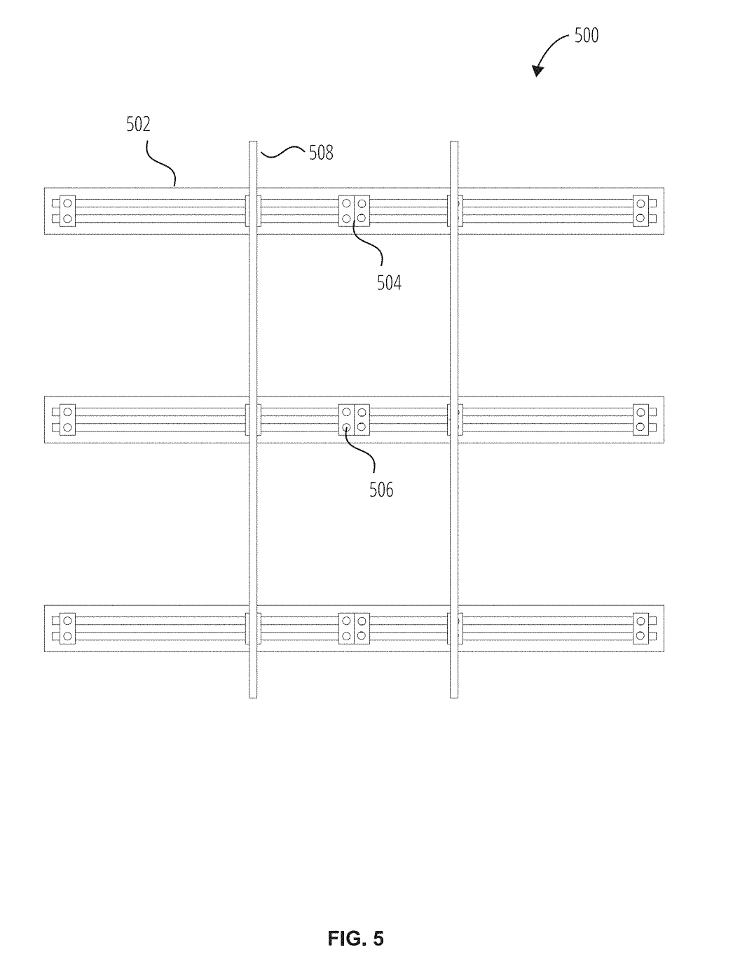

Referring to FIG. 5, a movable light array 500 may include a frame 502, a light assembly 504, a grow light 506, and a portion of the frame assembly 508. The light assembly 504 is attached to the frame 502 and the light assembly 504 includes at least one grow light 506. A portion of the frame assembly 508 is inserted or attached to a track assembly 218 (not shown). The light assembly 504 components are mounted in a horizontal configuration in FIG. 5. If the horizontal portions of the frame 502 were vertical instead of horizontal as shown, the light assembly 504 components may be mounted to the vertical members of the frame, thereby creating a vertical configuration of grow light assembly 504 components. In either a horizontal or vertical configuration, the grow light assembly 504 components are mounted in positions on the frame 502 such that all of the plants in a vertical stack plant assembly will receive appropriate light coverage and intensity to maximize plant quality, growth and health.

Any type of light may be used as a glow grow light 506 including fluorescent lights, high-intensity discharge lights, and LED grow lights. LED lights typically last longer than fluorescent lights and are capable of greater light intensity. One of skill in the art will realize that the grow lights within the light assembly or the light assembly itself may be adjusted up or down left or right within the frame assembly to achieve optimal photon efficacy at the plant canopy.

The grow light 506 may be an LED emitter. The light assembly 504 components may include multi-strip LED emitters. Each grow light 506 may be a “full-spectrum” light or may emit a certain frequency. Because each light assembly 504 may contain a plurality of grow lights, a wide range of frequencies may be produced by each light assembly 504 by turning on or off certain grow lights. If a full-spectrum of light frequencies is desired from a light assembly 504 containing non full-spectrum lights, then all of the grow lights in the light assembly 504 may be turned on.

Because most LED emitters have a large heat sink, heat buildup may become a problem. In an embodiment, heat transfer tape is applied to the LED emitter heat sinks, and the heat transfer tape is attached to a grounding cable that terminates into the earth outside of the plant space and the outer shell assembly. The grounding cable may include copper.

In an embodiment, the light assembly 504 may include an optical fiber lighting system. This system may include a light source, a light transmission device (e.g., optical fiber), and a light output device (e.g., lamp), for delivering the light to a plant. The optical fiber lamps may be located closer to the plants with the heat generating light sources located significantly away from the plants. In some embodiments, a solar optical fiber lighting system may be used. This system may include a light guiding device for collecting the sunlight, a light transmission device (e.g., optical fiber), and a light output device (e.g., lamp), for delivering the light to a plant. A light guiding device may be positioned on the roof and/or wall of the cube assembly, to collect sunlight. The optical fiber lamp “cone of light” may be physically constructed to focus on one plan, or the “cone of light” may be constructed to focus on several plants at once. In an embodiment, multiple optical fiber lamps may be physically arranged so that the light cones overlap in a more uniform pattern covering multiple plants.

A general control system may be used to control the grow lights. The system may control the on/off frequency, spectral frequency, and amplitude of the light emitted to the plants. The system may also simulate a certain time of day, a sunrise, and a sunset by manipulating the amplitude and spectral frequency of the lights.

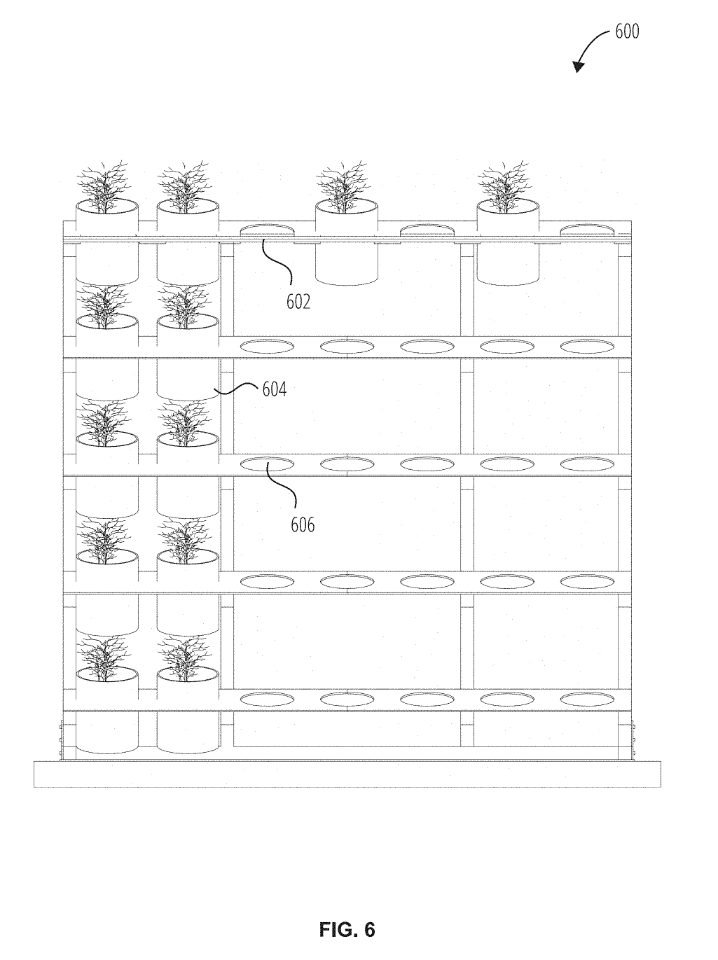

As shown in FIG. 6, a vertical stack plant assembly 600 may include a removable retaining bar 602, pots 604, and plant pot holders 606. The removable retain removable retaining bar 602 allows for the removal of the plant pots 604 from the plant pot holders 606. This may be useful when retrieving plant pots 604 located in the upper levels of the vertical stack plant assembly 600.

Herein, references to “one embodiment” or “an embodiment” do not necessarily refer to the same embodiment, although they may. Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

1. A method of growing plants, comprising:
providing a plant growing apparatus, the apparatus comprising:
a vertical stack plant assembly, wherein the vertical stack plant assembly includes rows of plant pot holders for pots, said pots adapted to include grow medium and plants;
a movable light array, wherein the position of the movable light array with respect to the plant pot holders is adjustable to allow light from the movable light array to be in position for growing plants in the plant pot holders of the vertical stack plant assembly; and
an outer shell assembly including at least one of a wall, a floor, a ceiling, and combinations thereof, thereby creating a plant space, wherein the plant space includes the vertical stack plant assembly and the movable light array;
placing pots including grow medium and plants into the plant pot holders;
providing light, water, and nutrients to the plants, wherein the light is provided by the movable light array, water is provided by a watering system, and nutrients are provided by a nutrient delivery system;
monitoring at least one of the environmental conditions, the grow medium composition, the condition of the grow medium, plant health, and combinations thereof; and
adjusting at least one of: the position of the movable light array to provide optimal light to the plants; the quantity of water and frequency of delivery of water by the watering system to provide optimal moisture to the plants; the quantity and type of nutrients and frequency of delivery of nutrients by the nutrient delivery system to provide optimal nutrients to the plants; and combinations thereof.

2. The method of claim 1, wherein the plants are cannabis plants.

3. The method of claim 1, wherein the movable light array comprises:
a light assembly including at least one grow light;
a frame assembly including a frame, wherein the light assembly is mounted on the frame assembly; and
a track assembly, wherein the track assembly includes a track that accepts a portion of the frame assembly and facilitates movement of the frame assembly toward or away from the vertical stack plant assembly.

4. The method of claim 3, wherein the frame assembly slides along the track assembly.

5. The method of claim 3, wherein the frame assembly includes a plurality of light assemblies, vertical members, and horizontal members, wherein the light assemblies are mounted on at least one of the horizontal members to create a horizontal pattern substantially parallel to the rows of the plant pot holders in the vertical stack plant assembly, the vertical members to create a vertical pattern substantially perpendicular to the rows of the plant pot holders in the vertical stack plant assembly, and combinations thereof.

6. The method of claim 1, wherein the movable light array comprises LED lights.

7. The method of claim 1, wherein the orientation of the movable light array with respect to the vertical stack plant assembly is at least one of vertical, horizontal, an angle between 0 degrees and 90 degrees, and combinations thereof.

8. The method of claim 1, further comprising a control system for controlling at least one of the environmental conditions inside the plant space, the movable light array, the watering system, the nutrient delivery system, and combinations thereof.

9. The method of claim 1, wherein the outer shell assembly comprises an internal surface exposed to the plant space and an external surface not exposed to the plant space and a vacuum layer between the internal surface and the external surface, wherein the vacuum layer provides thermal isolation between the internal surface and the external surface.

10. The method of claim 1, wherein the outer shell assembly comprises an internal surface exposed to the plant space and an external surface not exposed to the plant space, wherein the internal surface includes at least one of wall materials that reflect light, ceiling materials that reflect light, floor materials that reflect light, and combinations thereof.

11. The method of claim 1, wherein the nutrient delivery system comprises:
a nutrient delivery fluid;
a canister in fluid communication with the nutrient delivery fluid; and
a nutrient block inside of the canister, wherein the nutrient block includes a plurality of nutrient layers including a core portion and a shell layer, where the core portion and shell layer refer to relative locations of the layers along a cross-section of the block that is orthogonal to a longitudinal length of the block, and the core portion is an inner layer relative to the shell layer, nutrients are present in multiple layers surrounding a core portion of the nutrient block, wherein the outer layers of the nutrient block include nutrients that are beneficial to plants at a young age, the inner layers of the nutrient block include nutrients that are beneficial to plants at an older age, wherein upon exposure of the nutrient block to the nutrient delivery fluid, the shell layer of the nutrient block dissolves or erodes into the nutrient delivery fluid that carries the nutrients to the plants, thereby creating a new shell layer from the core portion.

12. A plant growing apparatus, comprising:
a vertical stack plant assembly, wherein the vertical stack plant assembly includes rows of plant pot holders for pots, said pots adapted to include grow medium and plants;
a movable light array, wherein the position of the movable light array with respect to the plant pot holders is adjustable to allow light from the movable light array to be in position for growing plants in the plant pot holders of the vertical stack plant assembly, wherein the movable light array comprises:
a light assembly including at least one grow light;
a frame assembly including a frame, wherein the light assembly is mounted on the frame assembly; and
a track assembly, wherein the track assembly includes a track that accepts a portion of the frame assembly and facilitates movement of the frame assembly toward or away from the vertical stack plant assembly;
an outer shell assembly including at least one of a wall, a floor, a ceiling, and combinations thereof, thereby creating a plant space, wherein the plant space includes the vertical stack plant assembly and the movable light array, wherein the outer shell assembly comprises an internal surface exposed to the plant space and an external surface not exposed to the plant space, wherein the internal surface includes at least one of wall materials that reflect light, ceiling materials that reflect light, floor materials that reflect light, and combinations thereof;
a nutrient delivery system for delivering nutrients to the plants, wherein the nutrient delivery system comprises:
a nutrient delivery fluid;
a canister in fluid communication with the nutrient delivery fluid; and
a nutrient block inside of the canister, wherein the nutrient block includes a plurality of nutrient layers including a core portion and a shell layer, where the core portion and shell layer refer to relative locations of the layers along a cross-section of the block that is orthogonal to a longitudinal length of the block, and the core portion is an inner layer relative to the shell layer, nutrients are present in multiple layers surrounding a core portion of the nutrient block, wherein the outer layers of the nutrient block include nutrients that are beneficial to plants at a young age, the inner layers of the nutrient block include nutrients that are beneficial to plants at an older age, wherein upon exposure of the nutrient block to the nutrient delivery fluid, the shell layer of the nutrient block dissolves or erodes into the nutrient delivery fluid that carries the nutrients to the plants, thereby creating a new shell layer from the core portion;
a watering system for watering the plants;
a control system for controlling at least one of the environmental conditions inside the plant space, the movable light array, the nutrient delivery system, the watering system, and combinations thereof; and
a monitoring system for monitoring the health of plants, the condition of grow medium, grow medium composition, and the environmental conditions.

13. The plant growing apparatus of claim 12, wherein the frame assembly slides along the track assembly.

14. The plant growing apparatus of claim 12, wherein the frame assembly includes a plurality of light assemblies, vertical members, and horizontal members, wherein the light assemblies are mounted on at least one of the horizontal members to create a horizontal pattern substantially parallel to the rows of the plant pot holders in the vertical stack plant assembly, the vertical members to create a vertical pattern substantially perpendicular to the rows of the plant pot holders in the vertical stack plant assembly, and combinations thereof.

15. The plant growing apparatus of claim 12, wherein the apparatus is a modular, stackable unit that can be stacked on top of at least one additional plant growing apparatus according to claim 12, thereby creating a vertical structure with at least two separate plant spaces.

16. A plant growing system, comprising:
a vertical stack plant assembly, wherein the vertical stack plant assembly includes rows of plant pot holders for pots, said pots adapted to include grow medium and plants;
a movable light array, wherein the position of the movable light array with respect to the plant pot holders is adjustable to allow light from the movable light array to be in position for growing plants in the plant pot holders of the vertical stack plant assembly, wherein the movable light array comprises:
a light assembly including at least one grow light;
a frame assembly including a frame, wherein the light assembly is mounted on the frame assembly, wherein the frame assembly includes a plurality of light assemblies, vertical members, and horizontal members, wherein the light assemblies are mounted on at least one of the horizontal members to create a horizontal pattern substantially parallel to the rows of the plant pot holders in the vertical stack plant assembly, the vertical members to create a vertical pattern substantially perpendicular to the rows of the plant pot holders in the vertical stack plant assembly, and combinations thereof; and
a track assembly, wherein the track assembly includes a track that accepts a portion of the frame assembly and facilitates movement of the frame assembly toward or away from the vertical stack plant assembly;
an outer shell assembly including at least one of a wall, a floor, a ceiling, and combinations thereof, thereby creating a plant space, wherein the plant space includes the vertical stack plant assembly and the movable light array, wherein the outer shell assembly comprises an internal surface exposed to the plant space and an external surface not exposed to the plant space, wherein the internal surface includes at least one of wall materials that reflect light, ceiling materials that reflect light, floor materials that reflect light, and combinations thereof;
a nutrient delivery system for delivering nutrients to the plants, wherein the nutrient delivery system comprises:
a nutrient delivery fluid;
a canister in fluid communication with the nutrient delivery fluid; and
a nutrient block inside of the canister, wherein the nutrient block includes a plurality of nutrient layers including a core portion and a shell layer, where the core portion and shell layer refer to relative locations of the layers along a cross-section of the block that is orthogonal to a longitudinal length of the block, and the core portion is an inner layer relative to the shell layer, nutrients are present in multiple layers surrounding a core portion of the nutrient block, wherein the outer layers of the nutrient block include nutrients that are beneficial to plants at a young age, the inner layers of the nutrient block include nutrients that are beneficial to plants at an older age, wherein upon exposure of the nutrient block to the nutrient delivery fluid, the shell layer of the nutrient block dissolves or erodes into the nutrient delivery fluid that carries the nutrients to the plants, thereby creating a new shell layer from the core portion;
a watering system for watering the plants;
a control system for controlling at least one of the environmental conditions inside the plant space, the movable light array, the nutrient delivery system, the watering system, and combinations thereof; and
a monitoring system, wherein the monitoring system monitors the health of plants, the condition of grow medium, grow medium composition, and the environmental conditions and communicates with the control system.
